(19) United States
(12) Patent Application Publication
(10) Pub. No.: US 2017/0237355 A1
(43) Pub. Date: Aug. 17, 2017

(54) DC-TO-DC CONVERTER COMPRISING A TRANSFORMER

(71) Applicant: RHEINISCH-WESTFALISCHE TECHNISCHE HOCHSCHULE AACHEN, AACHEN (DE)

(72) Inventors: MARCO STIENEKER, AACHEN (DE); RIK DE DONCKER, LEUVEN (BE)

(73) Assignee: RHEINISCH-WESTFALISCHE TECHNISCHE HOCHSCHULE AACHEN, AACHEN (DE)

(21) Appl. No.: 15/327,553

(22) PCT Filed: Jul. 22, 2015
(86) PCT No.: PCT/EP2015/066788

§ 371 Date: Apr. 20, 2017

(30) Foreign Application Priority Data
Jul. 24, 2014 (DE) 10 2014 214 542.2

(51) Int. Cl. H02M 3/335; H02M 1/14; H02M 1/34

(52) U.S. Cl. CPC H02M 3/33546; H02M 1/34; H02M 1/14; H02M 2001/0048

(57) ABSTRACT

The invention relates to a DC-DC converter as well as to a DC network having a DC-DC converter, and to a method to operate a DC network having a DC-DC converter, whereby the DC-DC converter comprises a circuit arrangement with two bridge connections having semiconductor switches and a transformer arranged between the bridge connections. The transformer is provided with a step switch by means of which the transformation ratio can be switched. Through the selection of the transformation ratio, the soft-switched range of the dual active bridge in the form of the DC-DC converter can be enlarged. Consequently, a purely capacitive snubber can be used as the snubber, as a result of which the switching losses can be reduced.

The invention relates to a DC-DC converter having a transformer. A DC topology with two bridge connections referred to as a dual active bridge (DAB) and with a transformer arranged in-between makes it possible to connect generating units such as, for example, wind power plants, photovoltaic installations, storage systems such as battery-charging devices, as well as to connect electric loads such as, for instance, drives, to DC networks. Moreover, DC networks with the same voltage or a different voltage can also be connected by means of this topology. A transformer ensures galvanic isolation.

The document titled “A Three-Phase soft-switched High-Power Density dc/dc Converter for High-Power Applications” published at the IEEE Industry Applications Society Annual Meeting 1988 as well as U.S. Pat. No. 5,027,264 titled “Power conversion apparatus for DC/DC conversion using dual active bridges” disclose a DC-DC converter with a three-phase system. In the DC-DC converter, there is a transformer situated between two bridge connections. This DC-DC converter can be used in the watt range all the way up to the gigawatt range. Here, all of the power electronic switching circuits are operated in the soft-switched range, as a result of which losses during the switching operations can be reduced and the switching frequency can be increased.

German patent application DE 3721591 A1 discloses a method for switching over the transformation ratio of a transformer on the primary side. The transformer is especially a medium-frequency transformer having a large voltage and current range during operation. Such transformers are used as high-voltage generators in X-ray generators that power an X-ray tube. In order to adapt the applied current and voltage, the transformer is provided with a step switch by means of which the transformation ratio of the transformer can be changed. Switching over the transformation ratio translates into a reduction of the primary current and thus also into a reduction of the mains current consumption and of the current flow via the control elements connected upstream from the transformer. A switch-off operation on the primary side upstream from the step switch for purposes of switching over the transformation ratio is carried out so that the contact elements of the step switch are not under load during the switching operation and consequently are hardly subject to any wear and tear.

The invention is based on the objective of the putting forward a DC-DC converter which makes it possible to attain greater efficiency.

This objective is achieved by means of a dual active bridge arrangement in that the soft-switched range of the dual active bridge is enlarged. The soft-switched operating range of the dual active bridge DC-DC converter is dependent on the power that is to be transmitted and on the ratio between the input voltage and the output voltage. The switching losses of the semiconductors used are minimized and the system efficiency is maximized within the soft-switched operating range. The objective according to the invention is achieved through the use of a transformer that is equipped with a step switch. The step switch allows the transformation ratio to be changed, as a result of which the operation remains within the soft-switched range.

Particularly in the case of large differences between the input voltage and the output voltage, the operation falls outside of this soft-switched range. The switching losses increase and the efficiency decreases. By changing the transformation ratio of the transformer, it is possible to remain within the soft-switched range.

In an advantageous embodiment of the invention, it is provided that purely capacitive snubbers are used with which capacitors are connected in parallel to the semiconductor switch in order to minimize the switch-off losses. When only snubber capacitors are used, the operation necessarily has to be in the soft-switched range, and it is not permissible to leave this range without expanding the DC-DC converter. This limitation is particularly critical if the DC-DC converter is being employed as a connection between two DC networks with varying voltages, or if energy storage systems which exhibit very pronounced voltage fluctuations are integrated into a DC network.

In a preferred embodiment in which there is no need for galvanic isolation, an autotransformer is used as the transformer. Autotransformers are commercially available at a much lower price.

Embodiments of the invention will be described below making reference to the figures.

The following is shown:

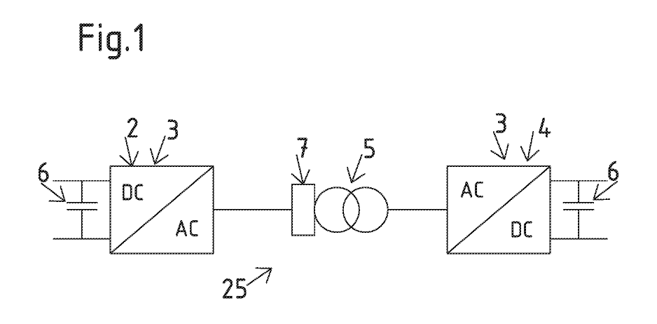

FIG. 1 a schematic view of a single-phase dual active bridge with a switchable transformer;

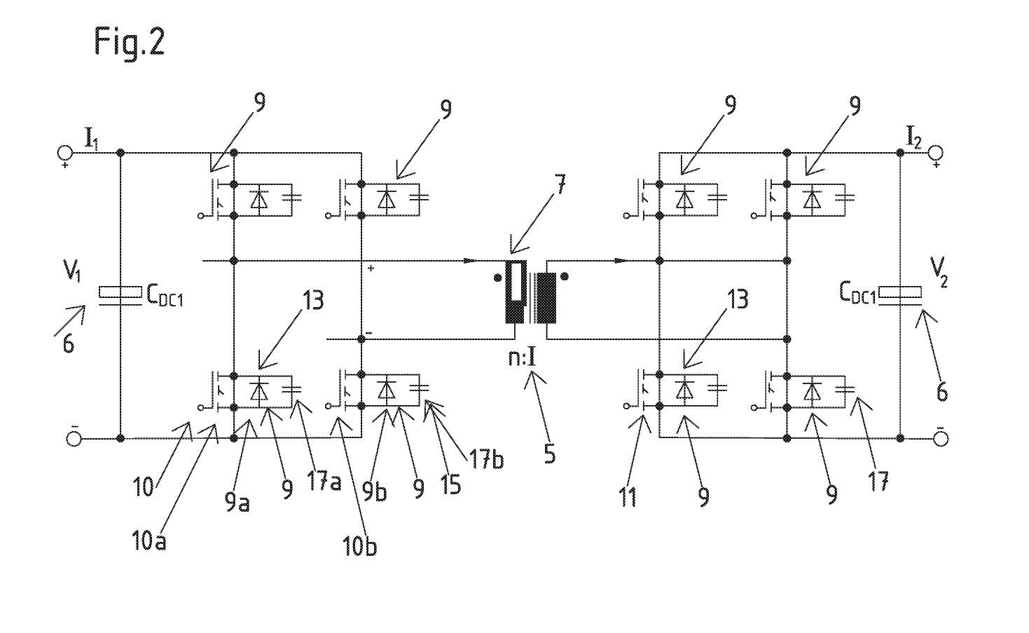

FIG. 2 a circuit diagram of a single-phase dual active bridge DC-DC converter with a power switch, relief capacitors (snubbers) and anti-parallel connected diodes;

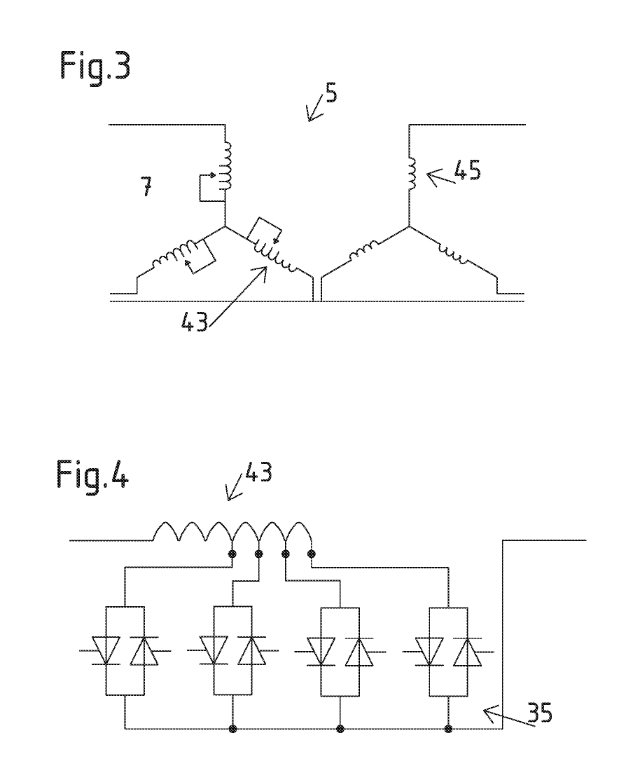

FIG. 3 a transformer for a three-phase dual active bridge with a mechanical step switch;

FIG. 4 a circuit diagram of a transformer with a step switch having semiconductor switches;

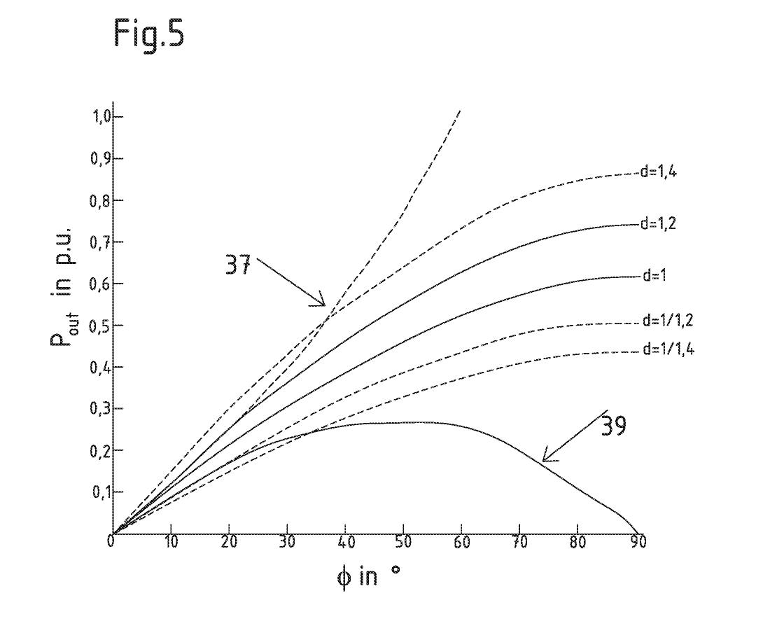

FIG. 5 a graph depicting the soft-switched range;

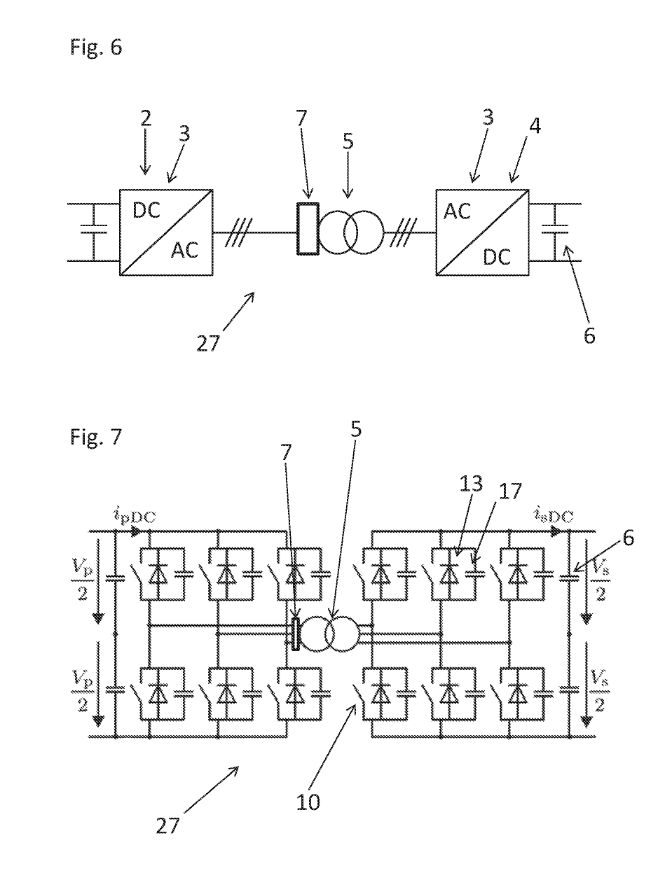

FIG. 6 a schematic view of a three-phase dual active bridge;

FIG. 7 a circuit diagram of a three-phase dual active bridge with a step switch.

FIG. 1 shows a schematic depiction of a DC-DC converter 1 in the form of a single-phase dual active bridge 25, referred to in short as a single-phase DAB. The DAB has a first bridge connection 3 with which the direct current is transformed into alternating current. The alternating current is transformed by a transformer 5 that is equipped with a step switch 7. The transformation ratio n of the transformer can be set by means of the step switch 7. The step switch 7 can be employed on the high-voltage side as well as on the low-voltage side. The alternating current generated by means of the transformer is converted back into a direct current by a subsequent second bridge connection 3. In this manner, the direct voltage that is present at the one side of the DAB can be converted into a different direct current. On both sides of the DAB, there is a smoothing capacitor 6 with which voltage fluctuations, also referred to as ripples, can be smoothed. These voltage fluctuations and ripples can be caused by faults in the connected systems (e.g. cable network, overhead line system) as well as by the switching operations of the DAB itself.

FIG. 2 shows a circuit diagram of a single-phase DAB 25. The configuration of a bridge connection 3 can be seen in the circuit diagram. In the embodiment shown, the bridge connections 3 are configured identically on both sides of the transformer 5. Each bridge connection 3 has four semiconductor switch modules 9 in the bridge connection. Each semiconductor switch module 9 comprises an IGBT 11 as the semiconductor switch 10. The use of other semiconductors such as MOSFETs or IGCTs is likewise technically conceivable. As long as one remains within the soft-switched range, MOSFETs and reverse-conducting IGBTs do not need any anti-parallel diodes. This embodiment, however, shows a diode 13 that is connected anti-parallel to the semiconductor switch. As the snubber 15, a capacitor 17, also referred to as C-snubber 17, is connected in parallel to the semiconductor switch 10. The transformer galvanically isolates the two bridge connections and thus the two sides of the DC-DC converter 1. Here, too, a smoothing capacitor 6 is connected in parallel to the bridge connection 3.

The galvanic isolation translates into advantages in terms of the design of the DAB 1 as well as of the higher quality of the transformed direct voltage, and it prevents the spread of malfunctions and faults that occur in the connected systems (both at the input and at the output).

Thanks to the galvanic isolation, the semiconductor switching modules 9 of the DAB, the isolation of the DAB from the ground potential as well as from the connected components (cables, generators, motors, protective devices, energy storage systems, etc.) only have to be dimensioned for the maximum voltage that can occur at the appertaining side of the transformer 5. This is particularly advantageous if the rated voltage between the input and the output varies due to the turns ratio of the transformer 5.

The galvanic isolation in DC-DC converters can only be implemented if the direct current is converted into alternating current. After the galvanic isolation by the transformer 5, the alternating current is rectified again. Voltage fluctuations (ripples) in the direct current affect the quality of the current in the generated alternating current. Thanks to the filtering effect of the transformer 5, certain faults or fluctuations from the one side of the transformer 5 are not transmitted to the other side. Consequently, these voltage fluctuations (ripples) are no longer present after the alternating current has been converted into direct current. This improves the quality of the transformed current that is subsequently stabilized by the DC-link capacitors.

These voltage fluctuations and ripples can be caused by faults in the connected systems (e.g. cable network, overhead line system). These faults are isolated when galvanically isolated DC-DC converters are used. Due to the galvanic isolation, the erroneous increase in the system voltage vis-à-vis the ground potential due to the occurrence of faults (for instance, short circuits between two originally isolated power networks, etc.) is likewise not passed on by the transformer.

Therefore, the DAB constitutes a suitable topology for use in future DC networks. The DAB can be employed as a control element between two distribution networks in order to regulate power flows. However, the DAB can also be used to link energy storage systems and renewable sources of energy (wind, solar, etc.). The power of the DAB in these fields of application lies in the multi-megawatt range. By connecting several DABs in series as well as in parallel, it is possible to build DAB systems whose total output corresponds to the sum total of the partial outputs.

C-snubbers 17, RC-snubbers and RCD-snubbers can all be used in the DAB 1 under consideration here. All of the snubber circuits 15 are connected in parallel to the semiconductor switch 10 (IGBT, IGCT, MOSFET) and to the diode 13. The C-snubber 17 is merely a capacitor, the RC-snubber is a series connection of a capacitor and a resistor, and in the case of the RCD-snubber, an additional diode is connected to the resistor of the RC-snubber. The C-snubber 17, also referred to as a “lossless snubber”, constitutes the most efficient solution. However, when C-snubbers 17 are used, under no circumstances is it permissible to depart from the soft-switched mode of operation, an aspect that will be explained in greater detail below.

When it comes to a DAB 1 of the performance class under consideration here (multi-megawatt all the way to the gigawatt range) and when the input and output voltages are in the medium-voltage range (≧1 kV), IGBTs 11 as well as IGCTs are employed as the semiconductor switches 10. Preference is given to the use of silicon IGBTs and IGCTs. However, serially connected MOSFETs are likewise conceivable. It is also possible to employ semiconductors on the basis of SiC and GaN. The advantage of IGBTs and IGCTs is that these high-performance components are commercially available and therefore can block and switch high voltages as well as conduct high currents without the need for complicated serial or parallel connections. Another feature is the high efficiency of these two technologies in multi-megawatt applications and in the thus typical switching frequencies in the kilohertz range. The switch-on losses of the semiconductor switch 10 can be minimized by adhering to certain operating ranges. The semiconductor switch 10 is always only switched on when the parallel-connected diode 13 is conducting current. This ensures that the voltage via the semiconductor switch 10 approaches zero and virtually no switch-on losses occur. Switch-off losses of the semiconductors can be reduced through the use of so-called snubber circuits 15.

In the soft-switched mode of operation, the diode 13 conducts the current when the appertaining adjacent semiconductor switch 10 is switched on. In this case, it is likewise ensured that the snubber capacitor 17 is discharged. In the hard-switched operating range, the diode 13 does not conduct any current the snubber capacitor 17 is charged to the input voltage. If the semiconductor switch 10 is then switched on, the charged snubber capacitor 17 is short-circuited and it is discharged via the semiconductor switch 10, for instance, an IGBT/IGCT. This can destroy the component. Therefore, the soft-switched mode of operation not only permits a high efficiency of the DAB 1 but also permits the use of lossless snubbers.

Another aspect limits the usability of lossless snubbers: the load current discharges the snubber capacitor 17 in the soft-switched mode of operation. If the snubber capacitor 17a has been discharged, then current continues to flow through the diode 9a (parallel to the capacitor 17a). The charging process of the snubber capacitor 17b—whose adjacent circuit breaker 10b has been switched off—takes place analogously to the discharging process of the capacitor 17a in parallel to the power semiconductor switch 10a which is supposed to be switched on directly. If the load current is not sufficiently large, the snubber capacitor 17a cannot be discharged in time before the semiconductor switch 10a is switched on. As in the case of the hard-switched mode of operation, this could cause the destruction of the component. Therefore, the usability of lossless snubbers is limited not only by the hard-switched operating range but also by a minimum power (minimum current) that has to be transmitted by the DAB 1.

If the power that is supposed to be transmitted by the DAB is not sufficiently large when the DAB is employed in wind power plants, the DAB cannot start up the operation with lossless snubbers. Through the use of energy storage systems (not shown here), the missing power needed to attain the minimum power can be added to the system. In this manner, the DAB equipped with snubber capacitors 17 can start up the operation.

If the ratio d of the input voltage to the output voltage diverges too much from one, the transformer current no longer lags behind the transformer voltage and the semiconductors are no longer operated in the soft-switched mode. FIG. 5 shows the boundaries as a function of d and of the power that is to be transmitted. Aside from the loss of the soft-switched mode of operation, the efficiency of the DAB also deteriorates if d diverges from one.

An adaptation of the turns ratio of the transformer 5 can enlarge the soft-switched operating range. The turns ratio is adapted using the step switch 7 by changing the tapping on the winding. The step switch 7 and thus also the tapping on the winding can be carried out mechanically, as shown in FIG. 3, as well as electronically, as shown by way of an example in FIG. 4 or in the document titled “A New Approach to Solid-State On Load Tap Changing Transformers” published in the IEEE Transaction on Power Delivery, vol. 13, no. 3, July 1998. In the electronic configuration, the various tapping operations are implemented via power semiconductors which, if applicable, permit bidirectional current conduction by means of an anti-parallel connection of two identical components. The appropriate power semiconductors are switched on or off as a function of the turns ratio that is to be set. The windings of the transformer 5 are designated by reference numeral 43 in FIGS. 3 and 4. Power semiconductors 35 that can be switched off as well as power semiconductors 35 that cannot be switched off (especially thyristors) can be employed in the electronic configuration. The step switches on the transformer that serve to set the turns ratio are configured in such a way that at least two states can be implemented. Preferred embodiments are step switches that can set any desired number of different turns ratios of the transformer. FIG. 5 is a view of the hard-switched operating range and of the soft-switched operating range. The standardized power P_{O} is plotted on the normal axis, the y-axis, as a function of the angle φ for various values of d. In this context, d indicates the voltage ratio of the DC-DC converter. The voltage ratio d between the input voltage and the output voltage also depends on the transformation ratio of the transformer 5. The voltage ratio of the transformer 5 can be changed by means of the step switch 7. As a result, the voltage ratio d can be changed so that the soft-switched range can be reached once again or else retained.

$${V}_{{s}^{′}} = \frac{{V}_{s}}{n}$$

$$d = \frac{{V}_{{s}^{′}}}{{V}_{p}}$$

Owing to the change of the turns ratio or voltage ratio n, no influence is exerted on the input voltage Vₚ or on the output voltage Vₛ, V_{s′}, in this application. The goal is to influence d by adapting n.

The soft-switched range of the dual active bridge arrangement is enlarged by means of a transformer whose transformation ratio n can be changed by means of a step switch. The soft-switched range is the range in which the semiconductor module 9 is still conductive when the semiconductor switch 10 is switched off. The boundary 37 between the soft-switched range of the bridge connection 3 on the input side is drawn in the diagram. Moreover, the boundary 39 between the soft-switched range and the hard-switched range of the bridge connection on the output side is marked. Operation within these boundaries is ensured by means of a superordinated regulation unit that influences the turns ratio as a function of operating parameters.

FIG. 6 shows a three-phase DAB 27. This three-phase DAB 27 has a first bridge connection 2 on the input side and a bridge connection 4 on the output side. A direct current is converted into an alternating current and vice versa by means of the bi-directional bridge connections 3.

Between the bridge connections, in turn, there is a transformer 5 that is equipped with a step switch 7. On the input and output sides, in turn, there is a smoothing capacitor 6.

A detailed view of the three-phase bridge connection is shown in FIG. 7. For purposes of providing a three-phase alternating current, six semiconductor modules 9 are connected to the bridge connection 3 on the input side of the transformer 5. In the same manner, six semiconductor modules 9 are connected to the bridge connections 3 on the output side. Each semiconductor module 9 has a semiconductor switch 10. GaN, silicon as well as silicon-carbide components such as MOSFETs, IGBTs and IGCTs can all be used in the envisaged field of application. Depending on the design of the semiconductor switch 10, a diode 13 and a snubber capacitor 17 are connected in parallel to the semiconductor switch 10.

Generally speaking, it holds true that the use of step switches translates into higher levels of efficiency, also in configurations of the single-phase DAB (1p-DAB) or the three-phase DAB (3p-DAB) without a snubber capacitor 17. The operation of the DC-DC converter at a voltage ratio that does not diverge a great deal from one reduces the reactive power in the transformer. This translates into fewer losses in the transformer as well as in the two power electronic converters. The reduction in the reactive power also makes it possible to configure a smaller transformer. This saves on material and lowers costs.

Fundamentally speaking, a distinction has to be made between single-phase DAB (1p-DAB) 25 and three-phase DAB (3p-DAB) 27. The advantage of the 1p-DAB 25 is the smaller number of semiconductor switches 10 that it needs, namely, eight, and the possibility to use a wide array of operating strategies in order to optimize the efficiency (soft-switched mode of operation). In contrast, the 3p-DAB 27 makes use of twelve semiconductor switches 10. The advantage of the 3p-DAB 27 lies especially in the fact that the dimensioning of the passive components that are needed, such as a transformer 5 and a smoothing capacitor 6, allows for smaller sizes than in the case of the comparable 1p-DAB 25. The soft-switched mode of operation is likewise possible with the 3p-DAB 27.

The magnetic flux interlinking in the transformers 5 determines the requisite cross sectional surface area of the transformer core used. For purposes of generating the same magnetic flux interlinking of a 3p-DAB 27 using a 1p-DAB 25, the input voltage or output voltage in only allowed to amount to 44% of the voltage of a 3p-DAB 27. Conversely speaking, this means that the cross sectional surface area and thus also the size (and costs) of the transformer 5 in a 1p-DAB are larger than those of the transformer 5 of a 3p-DAB 27 if the direct current is supposed to be the same for the 1p-DAB 25 as well as for the 3p-DAB 27.

The ripple of the direct currents in the case of a 3p-DAB 27 is less than in comparison to the ripple in the case of a 1p-DAB 25. As a result, the smoothing capacitor 6 at the input and output in the case of a 1p-DAB 25 has to have a higher capacitance. This is particularly the case if the dynamic voltage ratio d between the input voltage and the output voltage diverges from one. In this case, also the current that the smoothing capacitor picks up is very large. This likewise has to be taken into consideration in the dimensioning and it gives rise to drawbacks in terms of the size and the costs.

In summary, especially the following preferred features of the invention can be mentioned. The invention relates to an installation.

### LIST OF REFERENCE NUMERALS

1 DC-DC converter, dual active bridge
2 bridge connection on the input side
3 bridge connection
4 bridge connection on the output side
5 smoothing capacitor
7 step switch
9 semiconductor module
10 semiconductor switch
11 IGBT
13 diode
15 snubber circuit
17 snubber capacitor
21 power semiconductor switch of the step switch
25 single-phase DAB
27 three-phase DAB
33 switch of the step switch
35 power semiconductor of the step switch
37 limit on the input between the soft-switched and hard-switched ranges
39 limit on the output between the soft-switched and hard-switched ranges
43 primary winding of the transformer
45 secondary winding of the transformer

1. A DC-DC converter comprising:
a circuit arrangement with two bridge connections having semiconductor switche; and
a transformer arranged between the bridge connections, and equipped with a step switch configured to switch a transformation ratio of the transformer.

2. The DC-DC converter of claim 1, wherein the semiconductor switches comprise silicon semiconductors or semiconductors based on silicon carbide or gallium nitride.

3. The DC-DC converter of claim 1, wherein the transformer comprises an autotransformer.

4. The DC-DC converter of claim 1, wherein the semiconductor switches comprise:
IGBTs and/or IGCTs as power semiconductor switches, and
one or more diodes connected anti-parallel to corresponding ones of the power semiconductor switches, and
such that the DC-DC converter operates in the gigawatt range performance class.

5. The DC-DC converter of claim 1, wherein the DC-DC converter is a three-phase DC-DC converter.

6. The DC-DC converter according to one of the preceding of claim 1, comprising only one snubber capacitor as a snubber circuit in parallel to each of the semiconductor switches.

7. The DC-DC converter of claim 1, wherein the step switch has power semiconductor switches that can be switched off.

8. The DC-DC converter of claim 1, wherein the step switch has power semiconductors that cannot be switched off, the power semiconductors comprising thyristors.

9. A DC network having at least one DC-DC converter according to claim 1, the DC network having at least one energy storage system associated with the DC-DC converter to supply power to start up operation of the DC-DC converter based on a minimum current falling below a predetermined minimum power needed to operate the DC-DC converter.

10. A method of operating a DC network comprising at least one DC-DC converter having a circuit arrangement with two bridge connections having semiconductor switches and a transformer arranged between the bridge connections and equipped with a step switch configured to switch a transformation ratio of the transformer, the method comprising:
based on power provided from a current generated by a power generator falling below a predetermined minimum power that cannot be transmitted by the DC-DC converter feeding additional power from an energy storage system associated with the power generator to exceed the predetermined minimum power; and
feeding the power jointly provided by the power generator and by the energy storage system into the DC network via the DC-DC converter.

11. A DC network having a DC-DC converter according to claim 1, the DC network further comprising at least one energy generator equipped with or associated with the DC-DCconverter, whereby the current generated by the energy generator is fed into the DC network via the DC-DC converter.

12. The DC network of claim 11, wherein the at least one energy generator is a regenerative energy generator.

13. The DC network of claim 12, wherein the regenerative energy generator is a wind power plant.

14. The DC-DC converter of claim 2, wherein the transformer comprises an autotransformer.

15. The DC-DC converter of claim 3, wherein the semiconductor switches comprise:
IGBTs and/or IGCTs as power semiconductor switches, and
one or more diodes connected anti-parallel to corresponding ones of the power semiconductor switches,
such that the DC-DC converter operates in the gigawatt range performance class.

16. The DC-DC converter of claim 5, comprising only one snubber capacitor as a snubber circuit in parallel to each of the semiconductor switches.

17. The DC-DC converter of claim 6, wherein the step switch has power semiconductor switches that can be switched off.

18. The DC-DC converter of claim 6, wherein the step switch has power semiconductors that cannot be switched off.

19. The DC-DC converter of claim 18, wherein the power semiconductors comprise thyristors.

20. A DC network having at least one DC-DC converter according to claim 6, the DC network having at least one energy storage system associated with the DC-DC converter to supply power to start up operation of the DC-DC converter based on a minimum current falling below a predetermined minimum power needed to operate the DC-DC converter.
